(19) United States
(12) Patent Application Publication
(10) Pub. No.: US 2009/0127737 A1
(43) Pub. Date: May 21, 2009

(54) PRODUCTION APPARATUS AND PRODUCTION METHOD OF POLYMER FILM

(75) Inventors: Koju Ito, Kanagawa (JP); Satoshi Sakamaki, Kanagawa (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/295,026

(22) PCT Filed: Mar. 27, 2007
(86) PCT No.: PCT/JP2007/057368

§ 371 Date: Sep. 29, 2008

(30) Foreign Application Priority Data
Mar. 28, 2006 (JP) 2006-088199

(51) Int. Cl. B29D 7/01; B29C 39/14

(52) U.S. Cl. 264/212; 425/224

(57) ABSTRACT

A nozzle (55b) is disposed on a bottom (55a) of an air duct (55), and a drying air (56) is fed out from a nozzle (55b) toward a casting film (69). A data of a wind speed of the drying air (56) is input on a key board (100) to a controller (58), in which a height H of the air duct (55) from a casting belt (46) is calculated from the input wind velocity V. On the basis of the calculated height H, the controller (58) drives a shift device (102) to shift the air duct (55) up- and downwardly, such that the height H may be in the range of 20 mm to 300 mm.

### TECHNICAL FIELD

The present invention relates to a production apparatus and a production method of a polymer film.

### BACKGROUND ART

A cellulose acylate film is formed from cellulose acylate. For example, especially cellulose triacetate (hereinafter TAC) film is formed from TAC whose averaged acetylation degree is in the range of 58.0% to 62.5%. The TAC film is used as a film base of a film material, such as a photosensitive material, since having strength and inflammability. Further, the TAC film is excellent in optical isotropy, and therefore used as a protective film in a liquid crystal display whose market becomes larger in recent years.

The TAC film is usually produced by a solution casting method, in which the produced film is more excellent in physical properties, such as optical properties and the like, than other film production methods. For the solution casting method, polymer is dissolved to a mixture solvent in which dichloromethane or methyl acetate is main solvent component, and thus a dope as a polymer solution is prepared. Then the dope is cast from a casting die onto a support so as to form a casting film, while a bead of the dope is formed between the casting die and the support. When the casting film has a self-supporting property, the casting film is peeled as a wet film from the support. The wet film is dried and wound up. (see, Japan Institute of Invention and Innovation (JIII) Journal of Technical Disclosure No. 2001-1745).

In the solution casting method, a drying air is applied to a surface of the casting film in order to progress the drying of the casting film. However, the surface condition of the casting film sometimes becomes bad in some manners of applying the drying air. Therefore, Japanese Patent Laid-Open Publication No. 11-123732 teaches a production method of a TAC film, in which a dope in which a content of solvent is at least 300 wt. % is used. In this case, when the surface of the casting film is dried, content of the solvent to be evaporated from the casting film in a minute is reduced to at most 300 wt. %/min. Thus the smoothness of the surface becomes higher.

The dope is discharged and gets to the surface of the support at the casting position. In an area between the casting position and the position at which the application of the drying air starts, an aerial movement like a wind occurs naturally. Thus the surface condition of the casting film becomes bad, and the stripe-like or spot-like pattern, namely a mura, sometimes occurs on the surface. In Japanese Patent Laid Open Publication No. 2004-314527, an air shielding plate is disposed so as to cover the casting film in the area about 1000 mm downstream side from the casting die in the running direction of the support. Thus it is prevented that the aerial movement blows onto the surface of the casting film.

However, in the method of the publications No. 11-123732 the drying speed of the casting film is made slower, and therefore the productivity of the film is low. Further, in the method of the publications No. 2004-314527, the support runs so as to have a relative speed to the air shielding plate. Therefore, a wind also occurs in the area in which the air shielding plate is disposed. Consequently, the surface condition of the casting film also becomes bad.

An object of the present invention is to provide a production apparatus and a production method of a polymer film whose smoothness is increased by forming a smooth casting film.

### DISCLOSURE OF INVENTION

In order to achieve the object and the other object, a production apparatus for a polymer film of the present invention includes a moving support, a casting die for casting onto the support a casting dope containing a polymer and an organic solvent so as to form a casting film, and an air feeding device provided with confronting to the support for feeding a drying air to the casting film. A distance between the support and the air feeding device is in the range of 20 mm to 300 mm. The production apparatus has a drying device for drying the polymer film obtained by peeling the casting film.

Preferably the air feeding device has a box shape whose bottom is provided with a nozzle for feeding air, and the distance is a height between the support to the bottom. Particularly preferably when a wind speed of the drying air is described as V (m/s) and the height as H(m), a value α determined as α=V/H^{1/2} is in the range of 20 to 150. The production apparatus especially preferably, includes a moving device for moving the air feeding device in accordance with the wind speed V, and more especially a controlling device for controlling the wind speed V and a position of the moving device.

In a preferable embodiment of the present invention, the air feeding device has an air outlet directed in a moving direction of the support and the distance is a height between the support to an upper edge of the air outlet. Particularly preferably, when a wind speed of the drying air is described as V (m/s) and the height as H(m), a value α determined as α=V/H^{1/2} is in the range of 20 to 150. The production apparatus especially preferably, includes a moving device for moving the air feeding device in accordance with the wind speed V, and more especially a controlling device for controlling the wind speed V and a position of the moving device.

In another preferable embodiment, a time from forming the polymer film to applying the drying air onto the casting film is at most 15 seconds. Particularly preferably, the drying air is applied for at least 3 seconds.

In a production method of a polymer film of the present invention, a dope containing a polymer and an organic solvent is cast onto a support so as to form a casting film, and a drying air is fed to the casting film with use of an air feeding device apart from said support in the range of 20 mm to 300 mm, such that the casting film may have a surface layer having a larger surface tension than an undried inner layer. The polymer film obtained by peeling the polymer film is dried.

Preferably the air feeding device has a box shape whose bottom is provided with a nozzle for feeding air, and the distance is a height between the support to the bottom. Particularly preferably when a wind speed of the drying air is described as V (m/s) and the height as H(m), a value αdetermined as α=V/H^{1/2} is in the range of 20 to 150.

In a preferable embodiment of the present invention, the air feeding device has an air outlet directed in a moving direction of the support and the distance is a height between the support to an upper edge of the air outlet. Particularly preferably, when a wind speed of the drying air is described as V (m/s) and the height as H(m), a value α determined as α=V/H^{1/2} is in the range of 20 to 150.

In another preferable embodiment, a time for forming the polymer film to applying the drying air onto the casting film is at most 15 seconds. Particularly preferable the drying air is applied for at least 3 seconds.

Preferably a temperature of the drying air is in the range of 40° C. to 150° C.

According to the present invention, the drying air is fed to the casting film from the air feeding device apart from the support in the range of 20 mm to 300 mm, and then upper part of the casting film is dried to form the surface layer whose surface tension is higher than the inner layer. Thus the surface of the casting film becomes smooth, and therefore the smoothness of the produced film becomes larger.

### BRIEF DESCRIPTION OF DRAWINGS

FIG. 1 is a schematic diagram of a dope preparation line according to the present invention;

FIG. 2 is a schematic diagram of a film production line of the present invention;

FIG. 3A is a schematic diagram of an embodiment of a drying device in the film production line;

FIG. 3B is an exploded view of a casting film dried by the drying device in FIG. 3A;

FIG. 4A is a schematic diagram of another embodiment of a drying device in the dope production line;

FIG. 4B is an exploded view of a casting film dried by the drying device in FIG. 4A.

### BEST MODE FOR CARRYING OUT THE INVENTION

As polymer of this embodiment, the already known polymer to be used for the film production may be used. For example, cellulose acylate is preferable, and triacetyl cellulose (TAC) is especially preferable. TAC may be produced from cotton linter or cotton pulp, or a mixture of materials respectively obtained from cotton linter and cotton pulp, and preferable TAC is produced from cotton linter. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 mass. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.70. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinnamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinnamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion liquid that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

[Dope Production Method]

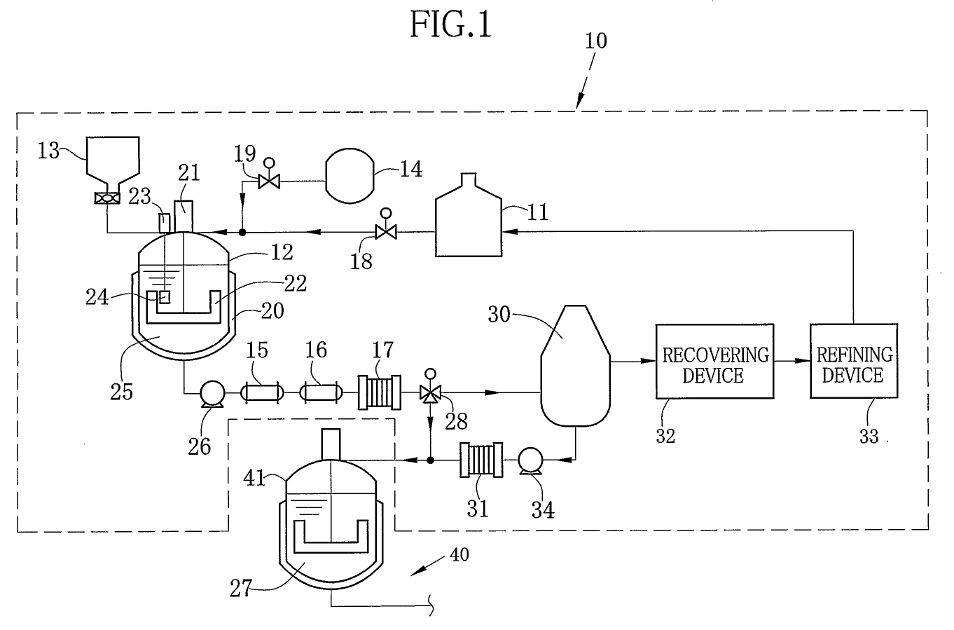

As shown in FIG. 1, a dope production line 10 is constructed of a solvent tank 11 for storing a solvent, a mixing tank 12 for mixing the TAC and the solvent therein, a hopper 13 for supplying the TAC and an additive tank 14 for storing an additive. Further, there is a heating device 15 for heating a swelling liquid (described below in detail), a temperature controller 16 for controlling the temperature of prepared polymer solution, and a filtration device 17. Further, there are a flush device 30 for concentrating the polymer solution and a filtration device 31. Further, there are a recovering device 32 for recovering a solvent vapor, and a refining device 33 for refining and recycling the recovered solvent. The dope production line 10 is connected to a stock tank 41 provided in a film production line 40.

In the dope production line 10, a casting dope 27 is produced in the following order. When a valve 18 is opened, the solvent is sent from the solvent tank 11 to the mixing tank 12. Amount of the solvent is controlled by adjusting the valve 18. Then the TAC in the hopper 13 is sent to the mixing tank 12. Thereafter, a valve 19 is opened such that the additive is sent from the additive tank 14 to the mixing tank 12.

The method of feeding the additive to the mixing tank is not restricted in the above description. If the additive is in the liquid state in the room temperature, it may be fed in the liquid state to the mixing tank 12 without preparing for the additive solution. Otherwise, if the additive is in the solid state in the room temperature, it may be fed in the solid state to the mixing tank 12 with use of a hopper. If plural sorts of additive compounds are used, the additive containing the plural additive compounds may be accumulated in the additive tank 14 altogether. Otherwise plural additive tanks may be used so as to contain the respective additive compounds, which are sent through independent pipes to the mixing tank 12.

In the above explanation, the solvent, the TAC, and the additive are sequentially sent to the mixing tank 12. However, the sending order is not restricted in it. For example, after the predetermined amount of the TAC is sent to the mixing tank 12, the feeding of the predetermined amount of the solvent and the additive may be performed to obtain a TAC solution. Otherwise, it is not necessary to feed the additive to the mixing tank 12 previously, and the additive may be added to a mixture of TAC and solvent in following processes.

The mixing tank 12 is provided with a jacket 20 covering over an outer surface of the mixing tank 12, a first stirrer 22 to be rotated by a motor 21, and a second stirrer 24 to be rotated by a motor 23. The first stirrer 22 preferably has an anchor blade, and the second stirrer 24 is preferably an eccentric stirrer of a dissolver type. The jacket is provided with a temperature controlling device for controlling the temperature of a heat transfer medium flowing in the jacket. Thus the inner temperature in the mixing tank 12 is controlled. The preferable inner temperature is in the range of −10° C. to 55° C. At least one of the first and second stirrers 22, 24 is adequately chosen for performing the rotation. Thus a mixture 25 in which the TAC is swollen in the solvent is obtained.

A pump 26 is driven such that the mixture 25 in the mixing tank 12 may be sent to the heating device 15 which is preferably a pipe with a jacket. Further, the heating device 15 preferably pressurizes the mixture 25. While the mixture 25 is continuously in only the heating condition or both of the heating and pressurizing condition, the dissolution of TAC proceeds such that the mixture 25 may be a polymer solution. Note that the polymer solution may be a solution in which the polymer is entirely dissolved and a swelling liquid in which the polymer is swollen. Further, the temperature of the mixture 25 is preferably in the range of 50° C. to 120° C. Instead of the heat-dissolution with use of the heating device 15, the mixture 25 may be cooled in the range of −100° C. to −30° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution is fed to the temperature controller 16, so as to control the temperature nearly to the room temperature.

Then the polymer solution is fed to the filtration device 31, such that impurities may be removed from the polymer solution. The filter material of the filtration device 31 preferably has an averaged nominal diameter of at most 100 μm. The flow rate of the filtration in the filtration device 31 is preferably at least 50 liter/hr. The polymer solution after the filtration is fed through a valve 28 to a stock tank 41.

The polymer solution can be used as the casting dope 27 for a film production, which will be explained. However, in the method in which the dissolution of TAC is performed after the preparation of the swelling liquid, if it is designated that a polymer solution of high concentration is produced, the time for production of such dope becomes longer. Consequently, the production cost becomes higher. Therefore, it is preferable that a polymer solution of the lower concentration than the predetermined value is prepared at first and then the concentrating of the polymer solution is made. In this embodiment, the polymer solution after the filtration is sent to the flush device 30 through the valve 28. In the flush device 30, the solvent of the polymer solution is partially evaporated. The solvent vapor generated in the evaporation is condensed by a condenser (not shown) to a liquid state, and recovered by the recovering device 32. The recovered solvent is recycled by a refining device 33 and reused. According to this method, the decrease of cost can be designated, since the production efficiency becomes higher and the solvent is reused.

The polymer solution after the concentrating as the above description is extracted from the flush device 30 through a pump 34. Further, in order to remove bubbles generated in the polymer solution, it is preferable to perform the bubble removing treatment. As a method for removing the bubble, there are many methods which are already known, for example, an ultrasonic irradiation method and the like. Then the polymer solution is fed to the filtration device 17, in which the undissolved materials are removed. Note that the temperature of the polymer solution in the filtration device 17 is preferably in the range of 0° C. to 200° C. The polymer solution after the filtration is stored in the stock tank 41, which is provided with a stirrer 61 rotated by a motor 60. The stirrer 61 is rotated so as to continuously stir the casting dope 27.

### [Solution Casting Method]

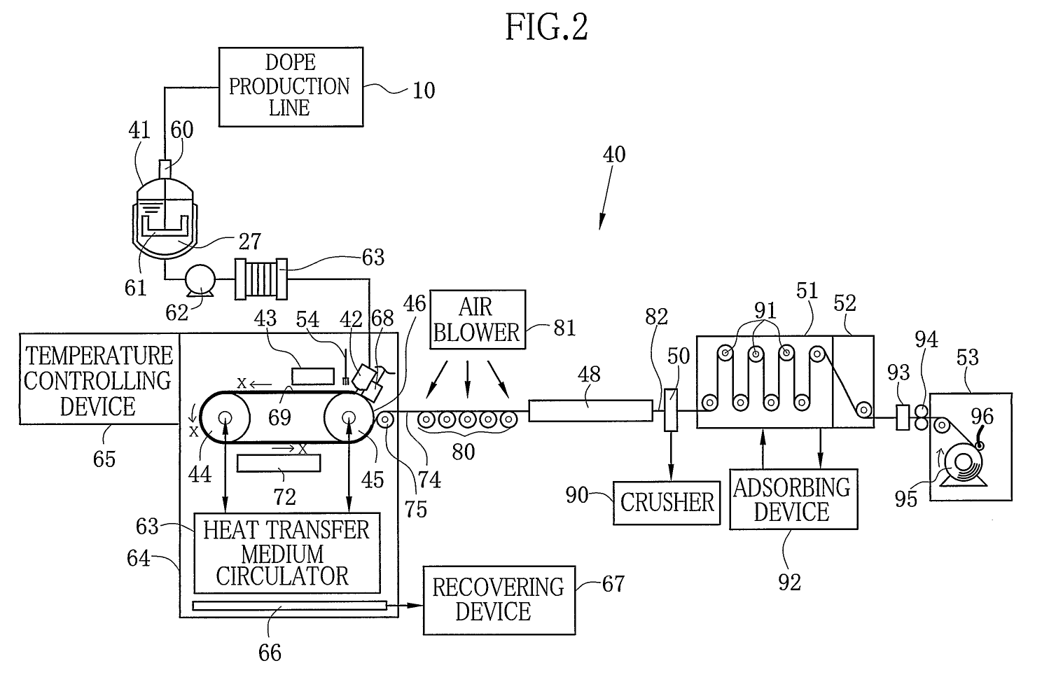

An embodiment of the solution casting method for producing a film of the present invention will be described in reference with FIG. 2, now. However, the present invention is not restricted in the embodiment. As shown in FIG. 2, the film production line 40 includes the stock tank 41, a filtration device 63, a casting die 42, back-up rollers 44, 45, a casting belt 46 supported by the back-up rollers 44, 45, and a tenter device 48. Further, there are an edge slitting device 50, a drying chamber 51, a cooling chamber 52 and a winding chamber 53.

In the stock tank 41, there is a stirrer 61 rotated by a motor 60. The stock tank 41 connects the dope production line 10 to the film production line 40, while being connected to the casting die 42 through a pump 62 and the filtration device 63.

The casting dope 27 is fed out from the stock tank 41 and cast onto the casting belt 46 by the casting die 42 so as to form a casting film 69. In a downstream from the casting die 42, there is a drying device 43 for drying the casting film 69 by feeding out a drying air to the casting film 69. Further, there is a labyrinth sealing 54 between the casting die 42 and the drying device 43. The labyrinth sealing 54 prevents the drying air fed rout from the drying air from flowing toward the casting die 42.

The back-up rollers 44, 45 are rotated by a driving device (not shown). In accordance with the rotation, the casting belt 46 runs or moves in a running direction (or a moving direction) X endlessly. The running speed of the casting belt is preferably in the range of 10 m/min to 200 m/min, particularly 15 m/min to 150 m/min, and especially 20 m/min to 120 m/min. If the casting speed is less than 10 m/min, the productivity of the film is not high. If the casting speed is more than 200 m/min, the discharged casting dope 27 cannot form a bead between the casting die 42 and the casting belt 46 stably, which causes the bad conditions of the surface of the casting film 69.

In order to control the surface temperature of the casting belt 46 to a predetermined value, it is preferable to provide a heat transfer medium circulator 70. It is preferable that the surface temperature of the casting belt 46 is adjusted in the range of −20° C. to 40° C. by heat transmission from the back-up rollers 44, 45. In this embodiment, paths (not shown) of the heat transfer mediums are formed in the back-up rollers 44, 45, and the heat transfer mediums whose temperatures are controlled by the heat transfer medium circulator 70 pass through the paths. Thus the temperature of the back-up rollers 44, 45 are kept to the predetermined values.

The width and the length of the casting belt 46 are not restricted especially. However, the width of the casting belt 46 is preferably 1.1 to 2.0 times as large as the casting width. Preferably, the length is from 20 m to 200 m, and the thickness is from 0.5 mm to 2.5 mm. The surface is preferably polished so as to have a surface roughness at most 0.05 μm. The casting belt 46 is preferably made of stainless steel, and especially of SUS316 so as to have enough resistance of corrosion and strength. The thickness unevenness of the entire casting belt 46 is preferably at most 0.5%.

Note that it is possible to use one of the back-up rollers 44, 45 as support. In this case, the roller is preferably rotated at high accuracy such that a flutter of rotation may be at most 0.2 mm. Therefore the surface roughness is preferably at most 0.01 μm. Further, the chrome plating is preferably performed to the drum such that the drum may have enough hardness and endurance. As described above, it is preferable in the support that the surface defect must be reduced to be minimal. Concretely there are no pin hole of at least 30 μm, at most one pin hole at least 10 μm and less than 30 μm, and at most two pin holes of less than 10 μm per 1 m².

The casting die 42, the casting belt 46 and the like are included in a casting chamber 64. A temperature controlling device 65 is provided for controlling the inner temperature of the casting chamber 64 to the predetermined value, and a condenser 66 if provided for condensing organic solvent evaporated in the casting chamber 64. Further, outside the casting chamber 64, there is a recovering device 67 for recovering the condensed organic solvent. In this preferable embodiment, there is a decompression chamber 68 for controlling the pressure in the back side of the bead. Thus the formation of a bead of the cast dope is stabilized.

In an interval section 80, there is an air blower 81 for feeding a drying air whose temperature is a predetermined value. Further, in downstream from the tenter device 48, there is an edge slitting device 50 to which a crusher 90 for crushing tips of the slit side edge portions of a film 82 is connected. Note that the explanation of the tenter device 48 will be made later.

The drying chamber 51 incorporates many rollers 91. Further to the drying chamber 51 is attached an adsorbing device 92 for adsorbing and recovering the solvent vapor which is generated in the evaporation of the solvent from the film 82. Further, in a downstream from the drying chamber 51, there is the cooling chamber 52 for cooling the film 82. Furthermore, a humidity control chamber may be provided for conditioning the humidity between the drying chamber and the cooling chamber 52.

In downstream from the cooling chamber 52, a compulsory neutralization device (or a neutralization bar) 93 eliminates the charged electrostatic potential of the film 82 to the predetermined value (for example, in the range of −3 kV to +3 kV). The position of the neutralization process is not restricted in this embodiment. For example, the position may be a predetermined position in the drying section or in the downstream side from a knurling roller 94, and otherwise, the neutralization may be made at plural positions. After the neutralization, the embossing of both side portions of the film 82 is made by the embossing rollers to provide the knurling. Further, in the winding chamber 53, there are a winding shaft 95 for winding the film 82 and a press roller 96 for controlling the tension of the film in the winding. Note that the emboss height from the bottom to the top of the embossment is in the range of 1 μm to 200 μm.

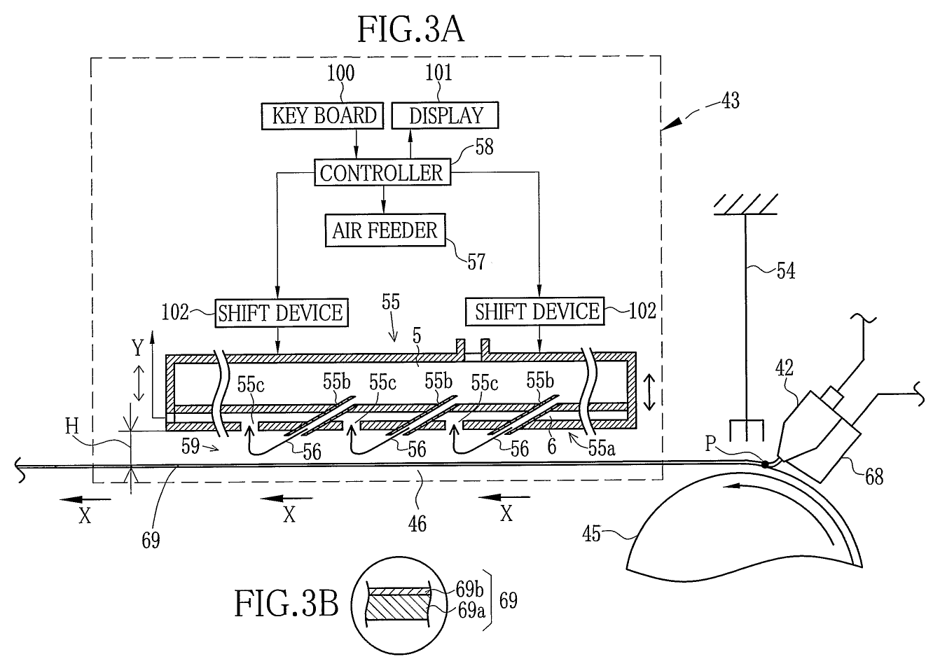

As shown in FIG. 3A, the drying device 43 includes an air duct 55 and an air feeder 57 for feeding a drying air 56 to the air duct 55. An outlet of the air duct 55 is directed in a running direction (X-direction) of the casting belt 46.

The air duct 55 is a box-like shape, and has a first chamber 5 for feeding a drying air therein from the air feeder, and a second chamber through which the discharged drying air is suctioned into the air duct 55. In the first chamber 5, a nozzle 55b for feeding out the drying air 56 is provided so as to protrude from a bottom 55a confronting to the casting film 69 on the casting belt 46. Further, the second chamber 6 has an inlet 55c near an outlet of the nozzle 55b, and the drying air is suctioned through the inlet 55c. The end of the nozzle 55b extends in a widthwise direction of the casting belt 46 and a number of the nozzle 55b is at least one. Further, if the number of the nozzle 55b is at least two, they are arranged in the running direction X of the casting belt 46. The drying air 56 is fed out through the nozzle 55b from the air duct 55 and thus applied to the casting film 69, and thus upper part of the casting film 69 is dried much more than lower part. Then part of the drying air 56 is aspirated through the inlet 55c into the air duct 55. Since the drying air 56 is applied to an exposure surface of the casting film 69, an evaporation of the solvent from the casting film 69 proceeds in a side of the exposure surface. Therefore, as shown in FIG. 3B, after the application of the drying air 56, since the upper part is dried well, the casting film 69 has an inner layer 69a and a surface layer 69b in which the solvent content is lower than the inner layer 69a. Thus the surface tension of the surface layer 69b is larger than the inner layer 69a, and therefore the smoothness of the film surface of the casting film 69 becomes larger. Further, in the following process, since the surface layer 69b is formed, the solvent content in the inner layer 69 is decreased gradually. When the casting film 69 is peeled from the casting belt 46, the content of the solid material in the casting film 69 becomes around 50%, such that the casting film 69 may have a self-supporting property. Note that the inlet 55c is disposed in a downstream side of the running direction X from the nozzle 55b. However, the inlet 55c may be disposed in an opposite side, namely an upstream side of the running direction X from the nozzle 55b. Further, the inlet 55c may be not provided.

In the present invention, a height H of a bottom 55a of the air duct 55 from the casting belt 46 is in the range of 20 mm to 300 mm, such that the surface layer 69b has a flat surface. Thus the produced film has a good surface condition. Further, in the present invention, if a wind speed of the drying air 56 is described as V (m/sec), a value α (m^{1/2}/sec) defined as α=V/H^{1/2} is preferably in the range of 20 to 150 such that the surface layer 69b may have a flat surface. Note that the wind speed V of the drying air 56 is at the outlet of the air duct 55. Further, in this embodiment, the wind speed V is regarded as that in a space 59 between the casting belt 46 and the air duct 55 although the in actually there is a small difference between the wind speed V and that in the space 59. If the wind speed V is not regarded as that in the space 59, an anemometer may be provided at a predetermined position in the space 59. In this case, the wind speed is controlled by a controller and the like.

Further there are several conditions for forming the surface layer 69b. A time from forming the casting film 69 at a casting position P on the casting belt 46 to the application of the drying air 56 to the casting film 69 is preferably at most 15 seconds, particularly at most 5 seconds, and especially at most 3 seconds. Further, the drying air 56 is preferably applied for at least 3 seconds to the casting film 69 in at most 15 seconds after the formation of the casting film 69. Further, the temperature of the drying air 56 is preferably in the range of 40° C. to 150° C., particularly 80° C. to 145° C., and especially 100° C. to 140° C. If the temperature is less than 40° C., the evaporation of the solvent from the casting film 69 doesn't proceed and therefore the solvent content in the casting film 69 hardly reduces. If the temperature is more than 150° C., the evaporation is made too fast and the bubbling occurs in the casting film 69. Anyway, in both of these cases, the surface layer 69b is hardly formed.

The drying device 43 further has a controller 58, a key board 100 as a data input device, a display 101 as a data display, a shift device 102 for shifting the air duct in shifting directions Y. The key board 100 and the display 101 are connected to controller 58. Further, the controller 58 is connected to the air feeder 57 for feeding the drying air to the air duct 55, and has a memory (not shown) for memorizing the input data on the key board 100. If the data is input on the key board 100, the controller 58 controls the wind speed V of the drying air 56 and drives a shift device 102 so as to shift the air duct 55 in the shifting directions Y, namely, up- and downward directions. The data to be input includes those of a wind speed V and the value α. The operator determines the value α in the range of 20 to 150, such that the produced film may become flat at most, and then the data of the value α is input on the key board 100. Thereafter, the data of the wind speed V is input on the key board 100 to the controller 58 in consideration with the circumstance conditions (for example, the temperature, the humidity and the like). Then the controller 58 calculates the value H^{1/2} according to a formula H^{1/2}=V/α (obtained from α=V/H^{1/2}), and the obtained value H^{1/2} is raised to the second power. Thus the height H is obtained. Thereafter, the controller 58 drives the shift device 102 to shift the air duct 55 to a position at the obtained value of the height H.

For example, there is a case in which the value α and a value V1 of the wind speed V has been input. In this case, if a larger value V2 of the wind speed V than the value V1 is input, the shift device 102 shifts the air duct 55 upwardly. Otherwise, if a smaller value V3 than the value V1 is input, the shift device 102 shifts the air duct 55 downwardly. As in this example, if the value a and the wind speed V of the drying air 56 are changed, the produced film can has high quality even in the change of the production conditions. Note that the height H may be input to the controller 58 such that the shift device 102 may be driven. However, in this case, the height H is determined in the range of 20 mm to 300 mm in order to make the surface of the casting film 69 flat.

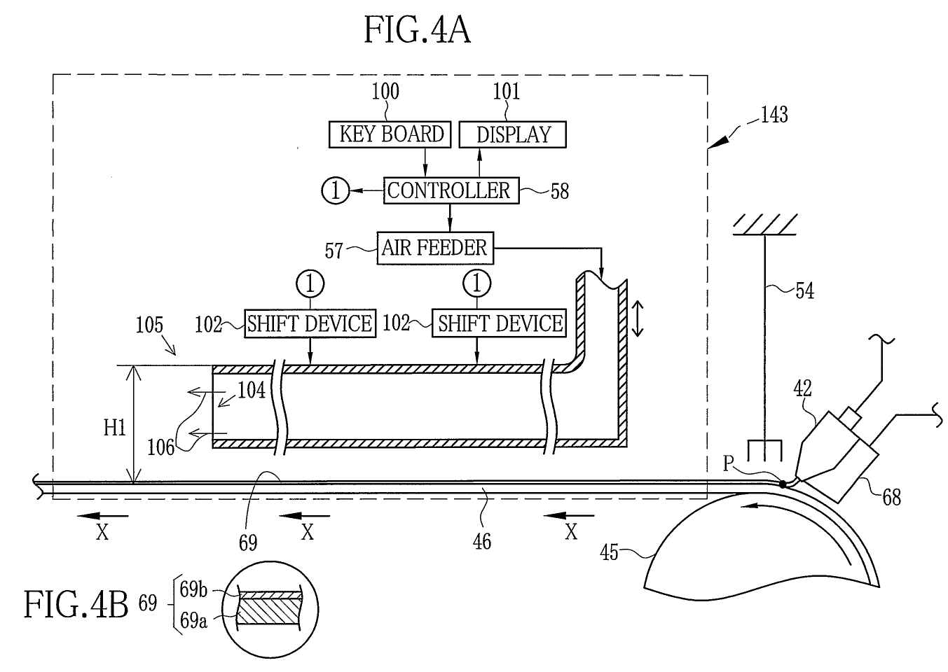

As shown in FIGS. 4A & 4B, the drying device 43 has a drying device 143 in which an air duct 105 is provided. An outlet 104 of the air duct 105 is directed in the running direction X. In this embodiment, the casting film 69 is dried by feeding out a drying air 106 through the outlet 104 from the air duct 105. Further, a height H1 of an uppermost of the outlet 106 from the casting belt 46 is in the range of 20 mm to 300 mm. Note that the same numbers are applied to the same members and the like as in FIG. 3.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the bead between a die slit (or die lip) and the support that the composition of alcohol is higher in the two outer dopes than the inner dope.

In this embodiment, the width of the product film is preferably in the range of 1400 mm to 2500 mm. However, even if the width is more than 2500 mm, the effect of the present invention can be obtained. Further, the thickness of the product film is preferably in the range of 20 μm to 100 μm, particularly 30 μm to 90 μm, and especially 40 μm to 80 μm.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of lubricants in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

An experiment of the present invention was made, and Examples 1-6 and Comparisons 1-4 in the experiment will be explained in followings. Among Examples 1-6 and Comparisons 1-4, the conditions of the film productions are the same except of the drying conditions for drying the surface of the casting film just after the casting.

[Experiment]

The production conditions of Example 1-6 and Comparisons 1-4 are as follows:

<Composition of Dope>

| | | |
|---|---|---|
| Cellulose Triacetate | 100 | pts. mass |
| (Powder: degree of substitution, 2.84; viscosity- | | |
| average degree of polymerization, 306; water | | |
| content, 0.2 mass %; viscosity of 6 mass % | | |
| dichloromethane solution, 315 mPa · s; averaged | | |
| particle diameter, 1.5 mm; standard deviation | | |
| of particle diameter, 0.5 mm) | | |
| Dichloromethane (first component of solvent) | 320 | pts. mass |
| Methanol (second component of solvent) | 83 | pts. mass |
| 1-butanol (third component of solvent) | 3 | pts. mass |
| Plasticizer A (triphenylphosphate) | 7.6 | pts. mass |
| Plasticizer B (diphenylphosphate) | 3.8 | pts. mass |
| UV-agent A | 0.7 | pts. mass |
| (2(2′-hydroxy-3′,5′-di-tert-butylphenyl)-5- | | |
| benzotriazol) | | |
| UV-agent B | 0.3 | pts. mass |
| (2(2′-hydroxy-3′,5′-di-tert-butylphenyl)-5- | | |
| chlorobenzotriazol) | | |
| Mixture of citric acid esters | 0.006 | pts. mass |
| (Mixture of citric acid, citric acid monoethyl | | |
| ester, citric acid dimethyl ester, citric acid | | |
| triethyl ester) | | |
| Particles | 0.05 | pts. mass |
| (silicon dioxide, particle diameter, 15 nm; | | |
| Mohs Hardness, about 7) | | |

(Cellulosetriacetate)

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton, and called cotton TAC in the following explanation.

(1) Preparation of Dope

The polymer solution was prepared with use of the dissolution tank having first and second stirrers that was made of stainless and 4000 L in volume. Into the dissolution tank, plural solvent components were mixed such that a mixture solvent was obtained. While the stirring of the mixture solvent was made, the cellulose triacetate flakes were added from the hopper to the mixture solvent gradually, such that the total mass of the mixture solution and the cellulose triacetate flakes might be 2000 kg. Note that the water content in each solvent component is at most 0.5 mass %. The stirring was made with use of the first stirrer having the anchor blade and the second stirrer which was eccentric stirrer of dissolver type. At first, the first stirrer performed the stirring at one m/sec as circumferential velocity, and the second stirrer performed the stirring at shear rate at first 5 m/sec. Thus the dispersion was made for 30 minutes during the stirring. The dissolving started at 25° C., and the temperature of the dispersion became 48° C. at last. After the dispersion, the high speed stirring (of the second stirrer) was stopped, and the stirring was performed by the first stirrer at 0.5 m/sec as circumferential velocity for 100 minutes. Thus cellulose triacetate flakes was swollen such that the swelling liquid was obtained. Until the end of the swelling, the inner pressure of the dissolution tank was increased to 0.12 MPa with use of nitrogen gas. At this moment, the hydrogen concentration in the dissolution tank was less than 2 vol. %, which does not cause the explosion. Further, water content in the polymer solution was 0.3 mass %.

(2) Dissolution & Filtration

The mixture 25 was fed to the heating device 15. The dissolving was made completely. The heating time was 15 minutes. The temperature of the mixture 25 is decreased to 36° C. by the temperature controlling device, and then filtrated through the filtration device having filtration material whose nominal diameter was 8 μm.

(3) Condensation, Filtration & Defoaming

The polymer solution was fed into the flush device 30 whose pressure was kept to the atmospheric pressure at 80° C., such that the flush evaporation of the polymer solution was made. The solvent vapor was condensed by the condenser to the liquid state, and recovered by the recovering device 32. After the flushing, the content of solid compounds in the polymer solution was 21.8 mass %. Note that the recovered solvent was recycled by the refining device 33 and reused. The anchor blade is provided at a center shaft of a flush tank of the flush device 30, and the polymer solution was stirred by the anchor blade at 0.5 m/sec as circumferential velocity. The temperature of the polymer solution in the flush tank was 25° C., the retaining period of the polymer solution in the flush tank was 50 minutes.

Then the defoaming was further made by irradiating very weak ultrasonic waves. Thereafter, the polymer solution was fed to the filtration device 31 by the pump under the application of pressure at 1.5 MPa. In the filtration device 31, the polymer solution was fed at first through a sintered fiber metal filter whose nominal diameter was 10 μm, and then through the same filter of 10 μm nominal diameter. At the forward and latter filters, the upstream side filtration pressures were respectively 1.5 MPa and 1.2 MPa, and the downstream side filtration pressures were respectively 1.0 MPa and 0.8 MPa. The temperature of the polymer solution after the filtration was controlled to 36° C., and stored as the casting dope 27 in the stainless stock tank 41 whose volume was 2000 L. The anchor blade is provided to a center shaft of the stock tank 41, and the casting dope 27 was always stirred by the anchor blade at 0.3 m/sec as circumferential velocity. Note that when the concentrating of the polymer solution is made, corrosions of parts or portions contacting to the polymer solution in the devices didn't occur at all.

Further, the mixture solvent A for preparing the additive liquid contained dichloromethane of 86.5 pts.mass, methanol 13 pts.mass, and n-butanol 0.5 pts.mass.

(4) Discharging

The film is formed in a film production line 40 shown in FIG. 1. The pump 62 for increasing the primary pressures was high accuracy gear pumps and driven to feed the casting dope 27 while the feed back control was made by an inverter motor. As for the pump 62, volumetric efficiency was 99.2%, and the variation rate of the discharging was at most 0.5%. Further, the discharging pressure was 1.5 MPa. Then the casting dope 27 filtrated through the filtration device was fed to the casting die 42.

The flow rate of the casting dope 27 near a die lip of the casting die 42 is controlled such that the dried film may be 80 μm in thickness, while the viscosity of the casting dope 27 was 20 Pa·s. The casting width of the casting dope 27 from the die lip was 1700 mm. The casting speed was 20 m/min. Further, a jacket (not shown) is provided for the casting die 42. The temperature of a heat transfer medium was controlled to 36° C. at the entrance of the jacket, such that the temperature of the casting dope 27 may be controlled to 36° C.

The casting die 42 was the coat hunger type, in which heat bolts for adjusting the film thickness were disposed at the pitch of 20 mm. Thus the film thickness (or the thickness of the dopes) is automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 40.

In the upstream side of the casting die 42, there is the decompression chamber 68. The decompression rate of the decompression chamber 68 was controlled in accordance with the casting speed, such that the pressure difference might occur in the range of one Pa to 5000 Pa between the upstream and downstream sides of the bead of the cast dope above the casting die. At this time, the pressure difference between both sides of a bead of the cast dope was determined such that the length of the bead might be from 20 mm to 50 mm. Further, the pressure in the upstream side of the running direction of the casting belt 46 was 150 Pa lower than the downstream side. Furthermore, an instrument was provided such that the temperature of the decompression chamber 68 might be set to be higher than the condensation temperature of the gas around the casting section. Further, the casting die 42 was provided with an edge aspiration device (not shown) for controlling the disorder of the edge portions of the casting bead. The edge aspiration device was adjustable such that the flow rate of the wind might be in the range of 1 L/min to 100 L/min. In this embodiment, the edge aspiration device was adjusted such that the flow rate might be in the range of 30 L/min to 40 L/min. furthermore, the decompression chamber 68 is provided with a jacket (not shown) into which a heat transfer medium at 35° C. was fed. Thus the inner temperature of the decompression chamber 68 is kept to a predetermined value.

(5) Drying of Casting Film

The casting dope 27 is cast onto the casting belt 46 to form the casting film 69. Thereafter, in this experiment, three conditions are changed, namely, time T from the forming the casting film 69 at the casting position P on the casting belt 46 to applying the drying air 56 to the casting film 69, the wind speed V (m/sec) of the drying air 56, and the height H. The conditions and the results of the experiment will be explained in detail later. According to other drying conditions than the time T, the wind speed V and the height H, the temperature of the drying air was 60° C., the percentage of the solvent vapor was 16%, and the temperature in the casting chamber 64 was kept at 35° C. by the temperature controlling device 65. Further, the stationary pressure fluctuation near the casting die 42 was controlled to ±1 by the labyrinth sealing 54.

(6) Back-up Roller and Casting Belt

A heat transfer medium at 5° C. was fed in the back-up roller 45 in a side of the casting die 42, and a heat transfer medium at 40° C. was fed in the back-up roller 44 in another side. The surface temperature of a middle area of the casting belt 46 just before the casting was 15° C., and the temperature difference to both side areas was at most 6° C.

The casting belt 46 was an endless stainless belt which was 2.1 min width and 70 min length. The thickness of the casting belt 46 was 1.5 mm, and the surface of the casting belt 46 was polished, such that the surface roughness might be at most 0.05 μm. The material was SUS316, which had enough corrosion resistance and strength. The thickness unevenness of the entire casting belt 46 was at most 0.5% of the predetermined value. The casting belt 46 was moved by rotating the back-up rollers 44, 45. At this moment, the tension of the casting belt 46 was controlled to 1.5×10⁵N/m². Further, the relative speed to each roller to the casting belt 46 changed. However, in this experiment, the control was made such that the difference of the relative speed between the back-up rollers 44, 45 was at most 0.01 m/min. Further the control was made such that the variation of the speed of the casting belt 46 was at most 0.5% to the predetermined value. The position of the belt in the widthwise direction was controlled with detection of the position of the side end, such that meandering in one circle of the moving casting belt 46 was reduced in 1.5 mm.

When the solvent content in the casting film 69 became 50 mass % on dry basis, the casting film 69 was peeled as the wet film 74 from the casting belt 46 by a roller 75. Further, the peeling tension was 1×10² N/m². In order to reduce the peeling defects, the percentage of the peeling speed (the draw of the peeling roller) to the speed of the casting belt 46 was controlled from 100.1% to 110%. The surface temperature of the wet film 74 was 15° C. The solvent vapor generated in the evaporation is condensed by the condenser 66 at −10° C. to a liquid state, and recovered by the recovering device 67. The water content of the recovered solvent was adjusted to at most 0.5%. Further, the air from which the solvent components were removed was heated again and reused for the drying air.

(7) Tenter Transporting, Drying, Slitting

The wet film 74 fed into the tenter device 48 was transported into the drying zone of the tenter device 48 and dried with use of the drying air, while both side edges of the wet film 74 was held by the tenter clips. The temperature of the tenter clips was controlled by feeding the heat transfer medium at 20° C. The transference of the tenter clips was made with use of chain, and the speed fluctuation of the sprocket was at most 0.5%.

The tenter device 48 was partitioned into three zones. The temperature of the drying air in each zone was 90° C., 110° C., 120° C. from the upstream side. The averaged drying speed in the tenter device 48 was 120 mass %/m on the dry basis. The condition of each zone was controlled such that the content of the remaining solvent in the film 82 might be 7 mass % at the exit of the tenter device 48. In the tenter device 48, the stretching of the wet film 74 in the widthwise direction was made as the transportation was made. If the percentage of the film width before the tenter device 48 was determined to 100%, the stretching ratio of the film width after the tenter device 48 was 103%. Further, the wet film 74 was drawn in the lengthwise direction between the roller 75 and the tenter device 48. The drawing ratio in percentage was 102%.

According to the stretching ratio in the tenter device 48, the difference of the actual stretching ratio was at most 10% between two positions which were at least 10 mm apart from the clipping position of the clips, and at most 5% between two positions which were 20 mm apart from the holding portions. In the side edge portions in the tenter device 48, the ratio of the length in which the fixation was made was 90%. The solvent vapor generated in the tenter device 48 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The wet film 74 was fed out as the film 82 from the tenter device 48.

In 30 seconds from exit of the tenter device 48, both side edge portions were slit off in the edge slitting device 50. In this experiment, each side portion of 50 mm in the widthwise direction of the wet film 74 was determined as the side edge portion, which were slit off by an NT type cutter of the edge slitting device 50. The slit side edge portions were sent to the crusher 90 by applying air blow from a blower (not shown), and crushed to tips about 80 mm². The tips were reused as raw material with the TAC frame for the dope production. The oxygen concentration in the drying atmosphere in the tenter device 48 was kept to 5 vol. %. Note that the air was substituted by nitrogen gas in order to keep the oxygen concentration at 5 vol. %. Before the drying at the high temperature in the drying chamber 51, the pre-heating of the film 82 was made in a pre-heating chamber (not shown in which the air blow at 100° C. was supplied.

(8) Drying & Neutralization

The film 82 was dried at high temperature in the drying chamber 64, which was partitioned into four partitions. Air blows whose temperatures were 120° C., 130° C., 130° C. and 130° C. from the upstream side were fed from air blowers (not shown) to the partitions. The transporting tension of each roller 91 to the film 82 was 100 N/m. The drying was made for ten minutes such that the content of the remaining solvent might be 0.3 mass %. The lapping angle of the roller 4 was 90° and 180°. The rollers 91 were made of aluminum or carbon steel. On the surface, the hard chrome coating was made. The surfaces of the rollers 91 were smooth or processed by blast of matting process. The swing of the roller in the rotation was in 50 μm. Further, the bending of the roller 91 at the tension of 100 N/m was reduced to at most 0.5 mm.

The solvent vapor contained in the drying air is removed with use of the adsorbing device 92 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The film 82 was transported to a first moisture controlling chamber (not shown). In the interval section between the drying chamber 64 and the first moisture controlling chamber, the drying air at 110° C. was fed. In the first moisture controlling chamber, the air whose temperature was 50° C. and dewing point was 20° C. was fed. Further, the film 82 was fed into a second moisture chamber (not shown) in which the curling of the film 82 was reduced. An air whose temperature was 90° C. and humidity was 70% was applied to the film 82 in the second moisture controlling chamber.

(9) Knurling & Winding

After the moisture adjustment, the film 82 was cooled to at most 30° C. in the cooling chamber 52, and then the edge slitting was performed. The compulsory neutralization device (or a neutralization bar) 93 was provided, such that in the transportation, the charged electrostatic potential of the film might be in the range of −3 kV to +3 kV. Further, the film knurling was made on a surface of each side of the film 82 by the knurling roller 94. The width of the knurling was 10 mm, and the knurling pressure was set such that the height from bottom to top of the film surface might be at most 12 μm larger in average than the averaged thickness.

The film 82 was transported to a winding chamber 110, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 82 was 80 μm in thickness and 1900 mm in width. The diameter of the winding shaft 95 was 169 mm. The tension pattern was set such that the winding tension was 300 N/m at first, and 200 N/m at last. The film 82 was entirely 3940 m in length. The cycle of winding dislocation was 400 m, and the oscillation width was in ±5 mm. Further, the pressure of the press roller 96 to the winding shaft 95 was set to 50N/m. The temperature of the film at the winding was 25° C., the water content was 1.4 mass %, and the content of the remaining solvent was 0.3 mass %. Through all processes, according to the drying speed, 20 mass % of the solvent in dry weight standard was evaporated per minute in average. Further, the loose winding and wrinkles didn't occur, and the film didn't transit in the film roll even in 10G impact test. Further, the roll appearance was good.

The film roll of the film 82 is stored in the storing rack of 55% RH at 25° C. for one month. Then the inspection was made in the same way as above, but the remarkable change of the film conditions was not recognized. Further, the adhesion of the film didn't occur in the film roll. After production of the film 82, any part of the casting film 69 formed of the dope was not recognized on the casting belt 46.

<Estimation of Film Surface>

In Examples 1-6 and Comparisons 1-4, the time T, the wind speed V of the drying air 56 and the height H were set as follows, and the surface conditions of the produced film 82 was made with eyes for the estimation of the film surface.

In Example 1, the time T was 3 seconds, the wind speed V was 20 m/s, and the height H was 0.02 m. The value α was 141.4.

In Example 2, the time T was 5 seconds, the wind speed V was 7 m/s, and the height H was 0.02 m. The value α was 49.5.

In Example 3, the time T was 5 seconds, the wind speed V was 12 m/s, and the height H was 0.05 m. The value α was 53.7.

In Example 4, the time T was 10 seconds, the wind speed V was 7 m/s, and the height H was 0.05 m. The value α was 31.3.

In Example 5, the time T was 5 seconds, the wind speed V was 12 m/s, and the height H was 0.20 m. The value α was 26.8.

In Example 6, the time T was 10 seconds, the wind speed V was 7 m/s, and the height H was 0.12 m. The value α was 20.0.

In Comparison 1, the time T was 30 seconds, the wind speed V was 20 m/s, and the height H was 0.02 m. The value α was 141.4.

In Comparison 2, the time T was 5 seconds, the wind speed V was 30 m/s, and the height H was 0.02 m. The value α was 212.1.

In Comparison 3, the time T was 3 seconds, the wind speed V was 3 m/s, and the height H was 0.20 m. The value α was 6.7.

In Comparison 4, the time T was 10 seconds, the wind speed V was 7 m/s, and the height H was 0.50 m. The value α was 9.9.

The estimation of the surface condition of the film 82 in this experiment will be shown in Table 1.

TABLE 1

| | T (s) | V (m/s) | H (m) | α | Estimation |
|---|---|---|---|---|---|
| Ex. 1 | 3 | 20 | 0.02 | 141.4 | Excellent |
| Ex. 2 | 5 | 7 | 0.02 | 49.5 | Excellent |
| Ex. 3 | 5 | 12 | 0.05 | 53.7 | Excellent |
| Ex. 4 | 10 | 7 | 0.05 | 31.3 | Excellent |
| Ex. 5 | 5 | 12 | 0.20 | 26.8 | Good |
| Ex. 6 | 10 | 7 | 0.12 | 20.2 | Usable |
| Co. 1 | 30 | 20 | 0.02 | 141.1 | Usable |
| Co. 2 | 5 | 30 | 0.02 | 212.1 | Not usable |
| Co. 3 | 3 | 3 | 0.20 | 6.7 | Not usable |
| Co. 4 | 10 | 7 | 0.50 | 9.9 | Not usable |

Ex.: Example (For instance, Ex. 1 means Example 1)
Co.: Comparison (For instance, Co. 1 means Comparison 1)
Excellent: the film surface was flat
Good: the film surface was substantially flat but there is slight unevenness on film surface
Usable: there is small unevenness on the film surface and the film was usable as some sorts of the optical film
Non-usable: there is unevenness on the film surface and the film wasn't usable as the optical film

Various changes and modifications are possible in the present invention and may be understood to be within the present invention.

1. A production apparatus for a polymer film, comprising:
a moving support;
a casting die for casting onto said support a casting dope containing a polymer and an organic solvent, so as to form a casting film;
an air feeding device provided with confronting to said support for feeding a drying air to said casting film, a distance between said support and said air feeding device being in the range of 20 mm to 300 mm; and
a drying device for drying said polymer film obtained by peeling said casting film.

2. A production apparatus claimed in claim 1, wherein said air feeding device has a box shape whose bottom is provided with a nozzle for feeding air; and
wherein said distance is a height between said support to said bottom.

3. A production apparatus claimed in claim 2, wherein when a wind speed of said drying air is described as V (m/s) and said height as H (m), a value α determined as α=V/H^{1/2} is in the range of 20 to 150.

4. A production apparatus claimed in claim 3, further comprising a moving device for moving said air feeding device in accordance with the wind speed V.

5. A production apparatus claimed in claim 4, further comprising a controlling device for controlling said wind speed V and a position of said moving device.

6. A production apparatus claimed in claim 1, wherein said air feeding device has an air outlet directed in a moving direction of said support; and
wherein said distance is a height between said support to an upper edge of said air outlet.

7. A production apparatus claimed in claim 6, wherein when a wind speed of said drying air is described as V (m/s) and said height as H1 (m), a value α determined as α=V/(H1)^{1/2} is in the range of 20 to 150.

8. A production apparatus claimed in claim 7, further comprising a moving device for moving said air feeding device in accordance with the wind speed V.

9. A production apparatus claimed in claim 8, further comprising a controlling device for controlling said wind speed V and a position of said moving device.

10. A production apparatus claimed in claim 1, wherein a time from forming said polymer film to applying said drying air onto said casting film is at most 15 seconds.

11. A production apparatus claimed in claim 10, wherein said drying air is applied for at least 3 seconds.

12. A production method of a polymer film, comprising steps of:
moving a support;
casting on said moving support a dope containing a polymer and an organic solvent, so as to form a casting film;
feeding a drying air to said casting film with use of an air feeding device apart from said support in the range of 20 mm to 300 mm, such that said casting film may have a surface layer having a larger surface tension than an undried inner layer; and
drying said polymer film obtained by peeling said casting film.

13. A production method claimed in claim 12, wherein said air feeding device has a box shape whose bottom is provided with a nozzle for feeding air; and
wherein said distance is a height between said support to said bottom.

14. A production method claimed in claim 2, wherein when a wind speed of said drying air is described as V (m/s) and said height as H (m), a value α determined as α=V/H^{1/2} is in the range of 20 to 150.

15. A production method claimed in claim 12, wherein said air feeding device has an air outlet directed in a moving direction of said support; and
wherein said distance is a height between said support to an upper edge of said air outlet.

16. A production method claimed in claim 15, wherein when a wind speed of said drying air is described as V (m/s) and said height as H1 (m), a value α determined as α=V/(H1)^{1/2} is in the range of 20 to 150.

17. A production method claimed in claim 12, wherein a time from forming said polymer film to applying said drying air onto said casting film is at most 15 seconds.

18. A production method claimed in claim 17, wherein said drying air is applied for at least 3 seconds.

19. A production method claimed in claim 12, wherein a temperature of said drying air is in the range of 40° C. to 150° C.
